(19) United States
(12) Patent Application Publication
(10) Pub. No.: US 2005/0212336 A1
(43) Pub. Date: Sep. 29, 2005

(54) Bicycle saddle

(76) Inventor: Daniel Lee, Nantou City (TW)

Correspondence Address: SEYFARTH SHAW, 55 EAST MONROE STREET, SUITE 4200, CHICAGO, IL, 60603-5803, US

(21) Appl. No.: 11/048,596

(22) Filed: Feb. 1, 2005

(30) Foreign Application Priority Data
Mar. 29, 2004 (TW) 093204769

(51) Int. Cl. B62J 1/02

(52) U.S. Cl. 297/208

(57) ABSTRACT

A bicycle saddle includes a support mount disposed below an underside wall of a seat body for engaging a seat post of a bicycle. A cushioning unit includes a mount member having a bottom end connected to the support mount and a shank extending upwardly along an axis, and a force bearing member secured to the seat body and movable along the axis relative to the mount member. A compression spring includes an upper spring end secured to the force bearing member, a lower spring end secured to the bottom end of the mount member, and an intermediate spring portion which surrounds and which is spaced apart from the shank in radial directions relative to the axis.

### BACKGROUND OF THE INVENTION

1. Field of the Invention

This invention relates to a bicycle saddle, more particularly to a bicycle saddle with a cushioning unit and a compression spring mounted on an underside of a seat body for absorbing shock applied to the seat body.

2. Description of the Related Art

A conventional bicycle saddle generally includes a seat body and a support mount which is disposed below an underside wall of the seat body to be connected to a seat post of a bicycle. Two coil compression springs have ends mounted on a rear portion of the underside wall of the seat body, and opposite ends connected to the support mount for absorbing shock and vibration applied to the seat body. However, during riding, the pedaling force exerted by the rider tends to result in swaying of the seat body such that the compression springs are deformed laterally to affect adversely the shock-absorbing effect.

### SUMMARY OF THE INVENTION

The object of the present invention is to provide a bicycle saddle which has a satisfactory shock-absorbing effect, and which has a cushioning unit for guiding deformation of a compression spring thereof.

According to this invention, the bicycle saddle includes a seat body which includes front and rear portions opposite to each other in a longitudinal direction, and which has an upper wall contoured to be adapted for sitting by a rider, and an underside wall opposite to the upper wall in an upright direction. A support mount is disposed below the underside wall, and is adapted to be connected to a seat post of a bicycle. At least one cushioning unit includes a mount member which has a bottom end connected to the support mount, and a shank extending upwardly of the bottom end along an axis in the upright direction, and a force bearing member which is secured to the rear portion of the seat body and which is disposed to be movable along the axis toward the bottom end under a pressing force applied to the upper wall of the seat body. At least one compression spring includes an upper spring end secured to the force bearing member, a lower spring end secured to the bottom end of the mount member, and an intermediate spring portion which surrounds and which is spaced apart from the shank in radial directions relative to the axis such that downward movement of the force bearing member results in movement of the upper spring end toward the lower spring end.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a perspective bottom view of the preferred embodiment of a bicycle saddle according to this invention; and

FIG. 2 is a sectional view of the preferred embodiment.

### DETAILED DESCRIPTION OF THE PREFERRED EMBODIMENT

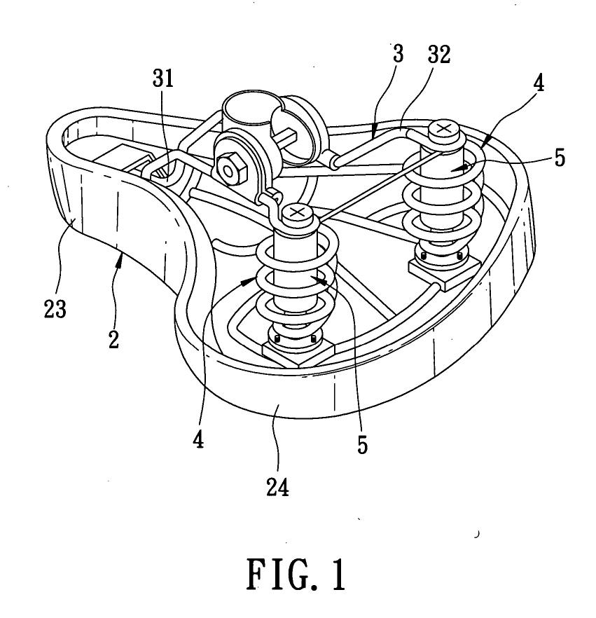

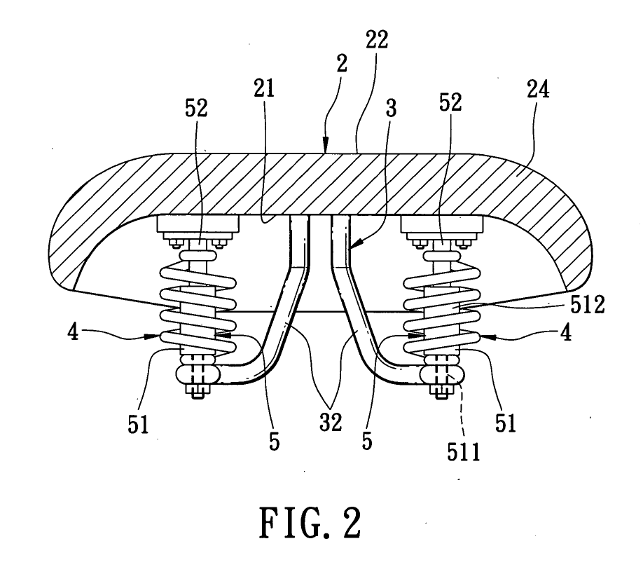

Referring to FIGS. 1 and 2, the preferred embodiment of a bicycle saddle according to the present invention is shown to comprise a seat body 2, a support mount 3, two cushioning units 5, and two compression springs 4.

The seat body 2 includes front and rear portions 23, 24 opposite to each other in a longitudinal direction, and has an upper wall 22 contoured to be adapted for sitting by a rider, and an underside wall 21 opposite to the upper wall 22 in an upright direction. The support mount 3 has a front end 31 which is secured on the underside wall 21 at the front portion 23, and two bracing bars 32 which extend rearwardly from the front end 31, which are disposed below the underside wall 21, and which are adapted to be connected to a seat post of a bicycle (not shown).

Each of the cushioning units 5 includes a mount member 51 and a force bearing member 52. The mount member 51 has a bottom end 511 which is connected to a respective one of the bracing bars 32, and a shank 512 which extends upwardly from the bottom end 511 along an axis in the upright direction. The shank 512 is in the form of a cylinder which defines an air chamber therein. The force bearing member 52 is in the form of a piston rod which extends into and which is movable relative to the air chamber along the axis, and which is secured to the rear portion 24 of the seat body 2.

Each of the compression springs 4 includes an upper spring end secured to the force bearing member 52, a lower spring end secured to the bottom end 511 of the mount member 51, and an intermediate spring portion in the form of a spiral which surrounds and which is spaced apart from the shank 512 in radial directions relative to the axis. In this embodiment, the lower spring end of the compression spring 4 is integrally formed with the respective bracing bar 32. Thus, when the force bearing member 52 is moved along the axis toward the bottom end 511 of the mount member 51 under a press force applied to the upper wall 22 of the seat body 2, the upper spring end of the compression spring 4 is moved toward the lower spring end along the axis to absorb shock without slanting from side to side, and air in the air chamber is compressed to provide a cushioning effect while imparting increased rigidity to the compression spring 4 in the upright direction. As a consequence, swaying of the seat body 2 from side to side during riding can be prevented.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

1. A bicycle saddle comprising:
a seat body which includes front and rear portions opposite to each other in a longitudinal direction, and which has an upper wall contoured to be adapted for sitting by a rider, and an underside wall opposite to said upper wall in an upright direction;
a support mount disposed below said underside wall, and adapted to be connected to a seat post of a bicycle;
at least one cushioning unit, which includes a mount member that has a bottom end connected to said support mount, and a shank extending upwardly from said bottom end along an axis in the upright direction, and a force bearing member that is secured to said rear portion of said seat body and that is disposed to be movable along the axis toward said bottom end under a pressing force applied to said upper wall of said seat body; and
at least one compression spring, which includes an upper spring end secured to said force bearing member, a lower spring end secured to said bottom end of said mount member, and an intermediate spring portion that surrounds and that is spaced apart from said shank in radial directions relative to the axis such that downward movement of said force bearing member results in movement of said upper spring end toward said lower spring end.

2. The bicycle saddle of claim 1, wherein said shank is in form of a cylinder which defines an air chamber therein, said force bearing member being in form of a piston rod which extends into and which is movable relative to said air chamber such that when said piston rod is moved toward said bottom end of said mount member, air in said air chamber is compressed to provide a cushioning effect while imparting increased rigidity to said compression spring in the upright direction.

3. The bicycle saddle of claim 1, wherein said lower spring end of said compression spring is integrally formed with said support mount.

4. The bicycle saddle of claim 3, wherein said intermediate spring portion of said compression spring is of a spiral shape.
